(19) United States
(12) Patent Application Publication
(10) Pub. No.: US 2007/0018414 A1
(43) Pub. Date: Jan. 25, 2007

(54) Stabilizer control apparatus

(75) Inventors: Yoshiyuki Yasui, Nagoya-shi (JP); Takashi Kondo, Toyota-shi (JP); Hideki Endo, Okazaki-shi (JP); Shuji Kamiya, Nagoya-shi (JP); Koichi Irie, Nagoya-shi (JP)

Correspondence Address: BUCHANAN, INGERSOLL & ROONEY PC, POST OFFICE BOX 1404, ALEXANDRIA, VA, 22313-1404, US

(73) Assignees: AISIN SEIKI KABUSHIKI KAISHA, Kariya-shi (JP); CHUO HATSUJO KABUSHIKI KAISHA, Nagoya-city (JP)

(21) Appl. No.: 11/482,158

(22) Filed: Jul. 7, 2006

(30) Foreign Application Priority Data
Jul. 25, 2005 (JP) 2005-213581

(51) Int. Cl. B60G 21/055

(52) U.S. Cl. 280/5.511; 280/124.107

(57) ABSTRACT

A stabilizer control apparatus for controlling a torsional rigidity of a stabilizer arranged between a right wheel and a left wheel of a vehicle includes a turning state detecting device for detecting a turning state quantity of the vehicle, and a switching device for switching the torsional rigidity of the stabilizer and including a first position in which a first torsional rigidity is achieved and a second position in which a lower torsional rigidity than the first torsional rigidity is achieved. The switching device switches between the first position and the second position based on the turning state quantity detected by the turning state detecting device. Further, the switching device switching the first position to the second position when a state in which the turning state quantity detected by the turning state detecting device is equal to or smaller than a predetermined value continues for a predetermined time or more.

### CROSS REFERENCE TO RELATED APPLICATIONS

This application is based on and claims priority under 35 U.S.C. § 119 to Japanese Patent Application No. 2005-213581, filed on Jul. 25, 2005, the entire content of which is incorporated herein by reference.

### FIELD OF THE INVENTION

This invention generally relates to a stabilizer control apparatus for a vehicle.

### BACKGROUND

A known stabilizer apparatus for a vehicle suspension is disclosed in JP2000-289427A. According to the stabilizer apparatus disclosed, in order to achieve both a rolling control effective on a turning road and an excellent ride comfort at a time of straight-ahead running on a general road, a torsion portion of the stabilizer is divided into right and left portions so that a clutch mechanism is provided at the divided portion. At a time of high-speed running or turning, the right and left portions of the torsion portion are connected to each other by means of the clutch mechanism so as to achieve the stabilizer function. On the other hand, at a time of low-speed straight-ahead running, the right and left portions of the torsion portion are disconnected from each other. Further, as a condition for controlling the clutch mechanism, a vehicle speed of 60 km/h or more, or a lateral acceleration of 0.4G or more are applied. These conditions are appropriately specified depending on vehicle characteristics, and the like.

According to the stabilizer apparatus disclosed, the stabilizer characteristics may be different depending on a direction of turning because of a phase difference between a lateral acceleration and a roll angle under the transient steering conditions such as a slalom running. Thus, the stabilizer characteristics are different between the right turning and the left turning, which may cause an uncomfortable feeling to a driver. As shown in FIG. 9, in the dynamics in which a rolling motion is caused in a vehicle because of a steering operation of a driver from the straight-ahead driving, a steering angle of wheels is generated first. When a slip angle of wheels is then generated, a lateral force is generated. As a drag against this lateral force, an inertia force (i.e. lateral acceleration) is acted on the vehicle, thereby causing a rolling motion. Therefore, the roll angle is generated after the lateral acceleration is generated.

For example, in FIG. 9, an operation of a steering wheel in a left turning direction is started at a time of t0. When the lateral acceleration reaches a threshold value at a time of t1, the clutch mechanism is brought to be in a connected state in which a roll angle is φ1, thereby starting to exert an effect of the stabilizer. Then, when the steering wheel is returned and therefore the lateral acceleration approaches a zero value, the clutch mechanism is brought to be in a disconnected state. Further, when the steering wheel is operated in a right turning direction and thus the lateral acceleration is increased, the clutch mechanism is again brought to be in the connected state at a time of t2. At this time, the roll angle is φ2, instead of φ1 that is obtained at a time of left turning when the clutch mechanism is in the connected state so as to achieve the effect of the stabilizer. Accordingly, at a time of transient steering, the condition for achieving the effect of stabilizer is different between the right turning and the left turning because of a phase difference between the lateral acceleration and the roll angle, which may cause a driver to have an uncomfortable feeling.

Thus, a need exists for a stabilizer control apparatus that can appropriately switch a torsional rigidity depending on a turning state of a vehicle so as to prevent a driver from having an uncomfortable feeling.

### SUMMARY OF THE INVENTION

According to an aspect of the present invention, a stabilizer control apparatus for controlling a torsional rigidity of a stabilizer arranged between a right wheel and a left wheel of a vehicle includes a turning state detecting means for detecting a turning state quantity of the vehicle, and a switching means for switching the torsional rigidity of the stabilizer and including a first position in which a first torsional rigidity is achieved and a second position in which a lower torsional rigidity than the first torsional rigidity is achieved. The switching means switches between the first position and the second position based on the turning state quantity detected by the turning state detecting means. Further, the switching means switching the first position to the second position when a state in which the turning state quantity detected by the turning state detecting means is equal to or smaller than a predetermined value continues for a predetermined time or more.

### BRIEF DESCRIPTION OF THE DRAWINGS

The foregoing and additional features and characteristics of the present invention will become more apparent from the following detailed description considered with reference to the accompanying drawings, wherein:

FIG. 1 is a block diagram of a stabilizer control apparatus according to an embodiment of the present invention;

FIG. 2 is a block diagram of the stabilizer control apparatus including a detailed structure of a first rigidity means, a second rigidity means, and a switching means according to an embodiment of the present invention;

FIG. 3 is a block diagram of the stabilizer control apparatus including a detailed structure of the first rigidity means, the second rigidity means, and the switching means according to an embodiment of the present invention;

FIG. 4 is a block diagram of a control system equipped with the stabilizer control apparatus according to the embodiment of the present invention;

FIG. 5 is a flowchart showing a switching control operation of a torsional rigidity of the stabilizer control apparatus according to the embodiment of the present invention;

FIG. 6 is a graph for setting a first threshold value and a second threshold value according to the embodiment of the present invention;

FIG. 7 is a time chart represented as time series of the control operation shown in FIG. 5.

FIG. 8 is a graph showing a relationship between a roll rigidity ratio and a fluctuation of a roll angle on a front wheel side; and

FIG. 9 is a time chart showing stabilizer characteristics difference between a right turning and a left turning because of a phase difference between a steering angle and a rolling motion at a time of transient steering.

### DETAILED DESCRIPTION

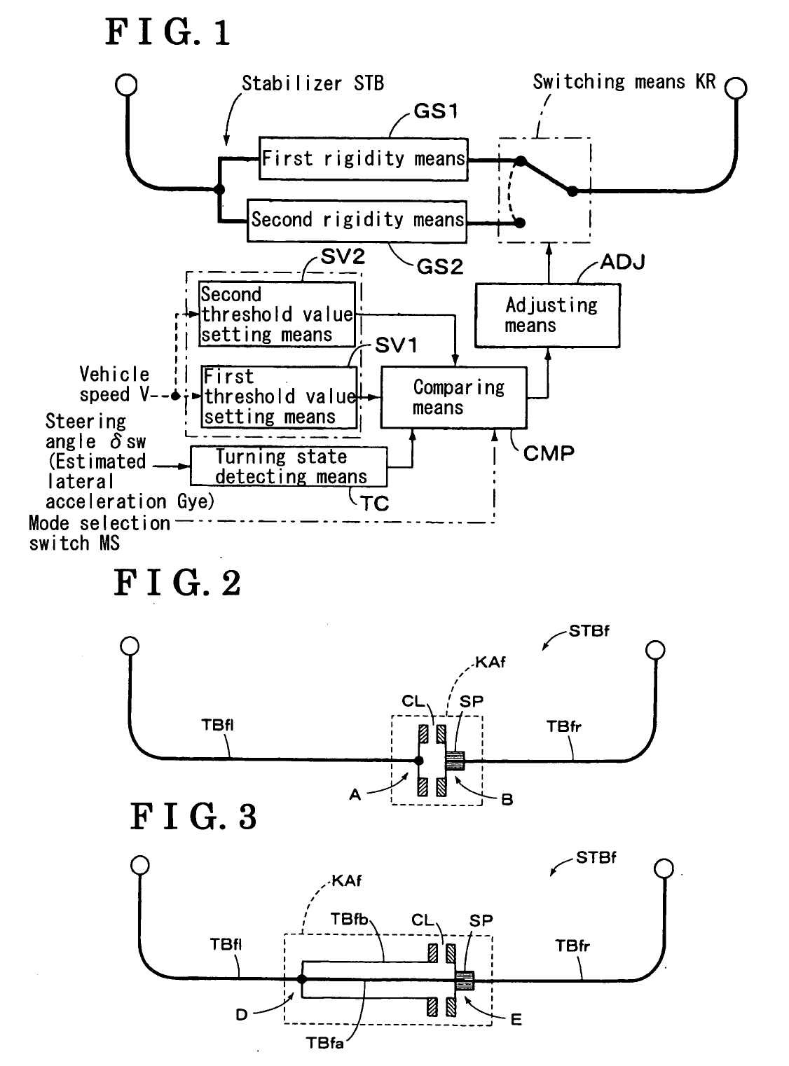

An embodiment of the present invention is explained with reference to the attached drawings. FIG. 1 is a view showing a structure of a stabilizer control apparatus according to the present embodiment. A stabilizer STB is arranged between a right wheel and a left wheel of a front wheel side of a vehicle, a rear wheel side, or both thereof. The stabilizer STB includes a first rigidity means GS1 for achieving a first torsional rigidity, a second rigidity means GS2 for achieving a second torsional rigidity that is smaller than the first torsional rigidity, and a switching means KR for switching between the first rigidity means GS1 and the second rigidity means. The first position in which the first torsional rigidity is achieved and the second position in which the second torsional rigidity smaller than the first rigidity of the stabilizer STB is achieved are switched therebetween by means of the first and second rigidity means GS1 and GS2, and the switching means KR on the basis of a turning state quantity detected by a turning state detecting means TC.

As a threshold value setting means, a first threshold value setting means SV1 for setting a condition for switching from the second rigidity means GS2 to the first rigidity means GS1, and a second threshold value setting means SV2 for setting a condition for switching from the first rigidity means GS1 to the second rigidity means GS2 are provided. The first threshold value and the second threshold value are both specified on the basis of a vehicle speed. Then, the first threshold value and the second threshold value, which are specified by the first threshold value setting means SV1 and the second threshold value setting means SV2 respectively, and the turning state quantity of a vehicle detected by the turning state detecting means TC are compared to each other by a comparing means CMP. The turning state quantity of a vehicle is a state quantity that represents a state in which the vehicle is turning. A steering angle, a lateral acceleration, a yaw rate, and a state quantity calculated on the basis thereof such as an estimated lateral acceleration calculated from the steering angle are used for the turning state quantity. In the cases where it is determined that the condition for switching the torsional rigidity of the stabilizer STB (i.e. switching condition) specified by the first threshold value or the second threshold value is satisfied, the switching means KR is driven so as to change the torsional rigidity of the stabilizer STB.

When the switching condition specified by the first threshold value is satisfied and it is determined that a switching from the second rigidity means GS2 to the first rigidity means GS1 is required, the switching means KR is immediately controlled so as to switch the torsional rigidity of the stabilizer STB. On the other hand, when the switching condition specified by the second threshold value is satisfied and it is determined that a switching from the first rigidity means GS1 to the second rigidity means GS2 is required, an adjusting means ADJ determines a time period (i.e. duration) during which the switching condition specified by the second threshold value is satisfied. When the duration time exceeds a predetermined time, the switching means KR is driven. Accordingly, since the torsional rigidity of the stabilizer STB is switched after the predetermined time during which the switching condition specified by the second threshold value is satisfied, a difference in stabilizer characteristics between a right turning and a left turning of a vehicle caused by a phase difference between the turning state quantity (steering angle, for example) and the rolling motion can be reduced.

The comparing means CMP receives a signal from a mode selection switch MS (hereinafter simply called a “switch MS”) operated by a driver. While the driver is selecting the first rigidity means GS1 (i.e. high torsional rigidity state) by means of the operation of the switch MS (hereinafter called “sports mode SM1”), the switching means KR is in the first position so as to be connected to the first rigidity means GS1. Thus, the controlling of the switching means KR based on a comparison between the turning state quantity and the first threshold value or the second threshold value is conducted only when the first rigidity means GS1 is not selected by the driver (hereinafter called “normal mode SM2”). Further, even if the normal mode SM2 is selected by means of the operation of the switch MS from the sports mode SM1 during the turning of the vehicle, the switching to the second rigidity means GS2 (i.e. low torsional rigidity state) is not conducted by the switching means KR unless the switching condition specified by the second threshold value is satisfied and at the same time the condition is kept for the predetermined time or longer. Accordingly, even if the driver activates the switch MS unnecessarily or by mistake so as to select the normal mode SM2 during the turning of the vehicle, the switching to the second rigidity means GS2 is prevented, thereby avoiding a rapid change of the rolling motion.

The first rigidity means GS1, the second rigidity means GS2, and the switching means KR are explained in detail with reference to FIGS. 2 and 3. FIGS. 2 and 3 are views for showing a stabilizer STBf arranged between a front right wheel and a front left wheel. A stabilizer STBr arranged between a rear right wheel and a rear left wheel has the same structure as that of the stabilizer STBf and is also constituted as shown in FIG. 1. In the following, the stabilizers STBf and STBr are explained as the stabilizer STB unless otherwise specifically distinguished. In FIG. 2, the first rigidity means GS1 that achieves the relatively high torsional rigidity of the stabilizer STB is constituted by a left wheel torsion bar TBfl and a right wheel torsion bar TBfr connected to each other by means of a clutch mechanism CL. In addition, in FIG. 3, the first rigidity means GS1 is constituted by the left wheel torsion bar TBfl and the right wheel torsion bar TBfr connected to each other through an intermediate torsion bar TBfa and a rigid member TBfb by means of the clutch mechanism CL.

The second rigidity means GS2 achieves the relatively low torsional rigidity of the stabilizer STB. In FIG. 2, the second rigidity means GS2 is constituted by the left wheel torsion bar TBfl and the right wheel torsion bar TBfr disconnected from each other (i.e. the stabilizer STB is prevented from achieving the torsional rigidity). In FIG. 3, the second rigidity means GS2 is constituted by the left wheel torsion bar TBfl and the right wheel torsion bar TBfr connected to each other only through the intermediate torsion bar TBfa by means of the clutch mechanism CL.

The first threshold value is used as a basis for switching to the first rigidity means GS1, i.e. to the high torsional rigidity (i.e. high level) from the low torsional rigidity (i.e. low level). The second threshold value is used as a basis for switching to the second rigidity means GS2, i.e. to the low torsional rigidity from the high torsional rigidity. The first and second threshold values are represented as the dimension of steering angle based on a vehicle speed V. Then, the first and second threshold values are compared to, for example, an actual steering angle δsw by the comparing means CMP. On the basis of the comparison result the switching means KR (i.e. the clutch mechanism CL in FIGS. 2 and 3) is driven.

The switching to the first rigidity means GS1 according to the present embodiment is conducted on the basis of a comparison result between the steering angle δsw and a first threshold value δ1. On the other hand, the switching to the second rigidity means GS2 is conducted first by comparing the steering angle δsw and a second threshold value δ2. Then, the adjusting means ADJ controls in such a way that the switching means KR is driven when the state in which the condition for switching to the second rigidity means GS2 is satisfied continues for the predetermined time or longer. Accordingly, since the switching to the second rigidity means GS2 is appropriately conducted by the adjusting means ADJ, the difference in stabilizer characteristics between the right turning and the left turning of the vehicle at a time of transient steering caused by a phase difference between the steering angle and the rolling motion as shown in FIG. 9 can be avoided.

A first threshold value Gy1 and a second threshold value Gy2, which are represented as the dimension of lateral acceleration, can also be applied. In this case, an estimated lateral acceleration Gye is obtained by the steering angle δsw and the vehicle speed V. Then, the estimated lateral acceleration Gye is compared to the first threshold value Gy1 or the second threshold value Gy2 so as to control the switching means KR.

In FIG. 2, the stabilizer STBf achieves the torsional rigidity by means of the left wheel torsion bar TBfl and the right wheel torsion bar TBfr. The left wheel torsion bar TBfl is fixed to one side member of the clutch mechanism CL at a connecting portion A. On the other hand, the right wheel torsion bar TBFr is fixed to the other side member of the clutch mechanism CL in such a manner that a rotational movement of the right wheel torsion bar TBfr is restricted and guided by a spline SP at a connecting portion B. The other side member of the clutch mechanism CL is driven by a driving means (not shown) in an axial direction (i.e. right and left direction in FIG. 2) so that the clutch mechanism CL is brought to the connected state or to the disconnected state. Accordingly, the torsional rigidity of the stabilizer STBf is controlled by means of the connection and disconnection of the clutch mechanism CL.

A state in which the clutch mechanism CL is in the connected position, i.e. the left wheel torsion bar TBfl and the right wheel torsion bar TBfr are connected to each other, represents the first rigidity means GS1 in FIG. 1. In this state, the high torsional rigidity of the stabilizer STBf is achieved. Meanwhile, a state in which the clutch mechanism CL is in the disconnected position, i.e. the left wheel torsion bar TBfl and the right wheel torsion bar TBfr are disconnected to each other, represents the second rigidity means GS2 in FIG. 2. In this state, the torsional rigidity of the stabilizer STBf is nil and the low torsional rigidity is achieved.

FIG. 3 shows a structure of low torsional rigidity, which is different from that of FIG. 2. The left wheel torsion bar TBfl is fixed to one side member of the clutch mechanism CL by means of the cylindrical rigid member TBfb. On the other hand, the right wheel torsion bar TBfr is connected to the other side member of the clutch mechanism CL in such a manner that a rotational movement of the right wheel torsion bar TBfr is restricted and guided by a spline SP at a connecting portion E. In addition, the intermediate torsion bar TBfa having the torsional rigidity is arranged between a connecting portion D where the left wheel torsion bar TBfl and the rigid member TBfa are connected to each other, and the connecting portion E. When the other side member of the clutch mechanism CL is driven by a driving means (not shown) in an axial direction (i.e. right and left direction in FIG. 3), the clutch mechanism CL is brought to the connected state or to the disconnected state. Accordingly, the torsional rigidity of the stabilizer STBf is controlled by means of the connection and disconnection of the clutch mechanism CL.

A state in which the clutch mechanism CL is in the connected position, i.e. the left wheel torsion bar TBfl and the right wheel torsion bar TBfr are connected to each other by means of the intermediate torsion bar TBfa and the rigid member TBfb, represents the first rigidity means GS1 in FIG. 1. In this state, the high torsional rigidity of the stabilizer STBf is achieved. Meanwhile, a state in which the clutch mechanism CL is in the disconnected position, i.e. the left wheel torsion bar TBfl and the right wheel torsion bar TBfr are connected to each other only by means of the intermediate torsion bar TBfa, represents the second rigidity means GS2 in FIG. 1. In this state, the low torsional rigidity of the stabilizer STBf is achieved.

The example of structure of the stabilizer STB is explained above. However, the structure of the stabilizer according to the present embodiment is not limited to the above. For example, the stabilizer can be provided at a link member between a suspension member and a torsion bar, or a switching mechanism can be provided at a member that supports a torsion bar. Any structures that can achieve a switching between the high torsional rigidity (first rigidity means) and the low torsional rigidity (second rigidity means) are acceptable.

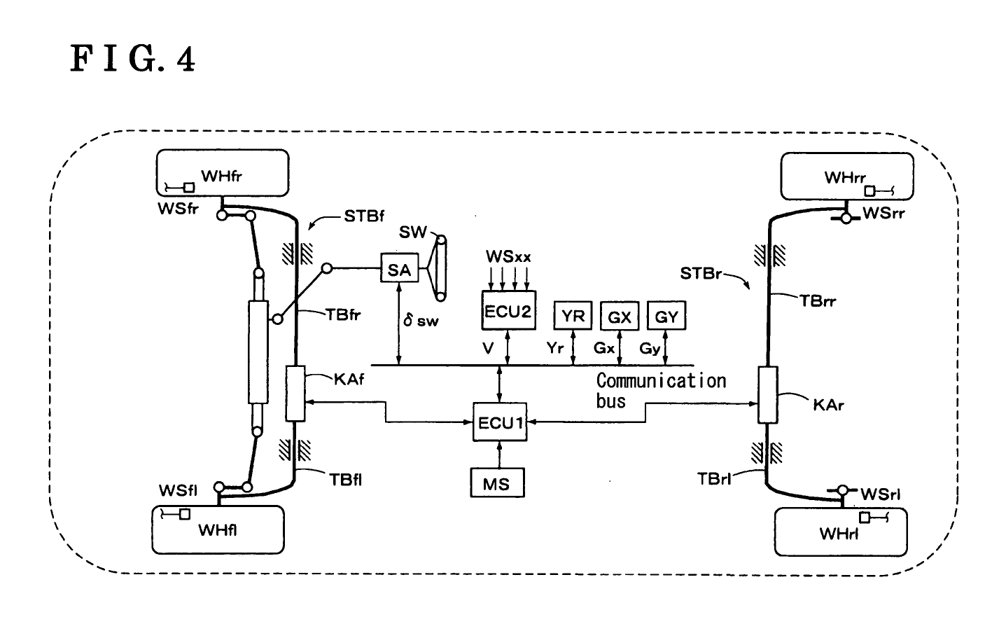

FIG. 4 is a view showing a control system equipped with a stabilizer control apparatus according to the present embodiment. The stabilizers STBf and STBr that can switch the torsional rigidity are provided on a vehicle. The stabilizers STBf and STBr include actuators KAf and KAr respectively for switching the torsional rigidity. The actuators KAf and KAr are controlled by an electronic control unit ECU1 for the stabilizer. The mode selection switch MS is connected to the electronic control unit ECU1 so that a driver can change the torsional rigidity of the stabilizers STBf and STBr by the switch operation.

The electronic control unit ECU1 is connected to a communication bus through which the electronic control unit ECU1 shares process information and a sensor signal of an electronic control unit for other control systems such as an electronic control unit ECU2 for the brake system. Further, a steering angle sensor SA for detecting a steering angle δsw of a steering wheel SW, a longitudinal acceleration sensor GX for detecting a longitudinal acceleration Gx of a vehicle, a lateral acceleration sensor GY for detecting a lateral acceleration Gy of a vehicle, and a yaw rate sensor YR for detecting a yaw rate Yr of a vehicle are all connected to the communication bus so as to provide information of a sensor signal to each electronic control unit.

Wheel sensors WSxx (“xx” replaces: “fr” indicating the front right wheel; “fl” indicating the front left wheel; “rr” indicating the rear right wheel; and “rl” indicating the rear left wheel, respectively) are provided at wheels WHxx, respectively. The wheel sensors WSxx are connected to the electronic control unit ECU 2 for the brake system so that a rotation speed of each wheel, i.e. a pulse signal with pulse numbers in proportion to a wheel speed, is input to the electronic control unit ECU2. In the electronic control unit ECU2 for the brake system, a longitudinal speed V of a vehicle (i.e. a vehicle speed V) is calculated on the basis of wheel speed signals Vwxx from the wheel speed sensors WSxx.

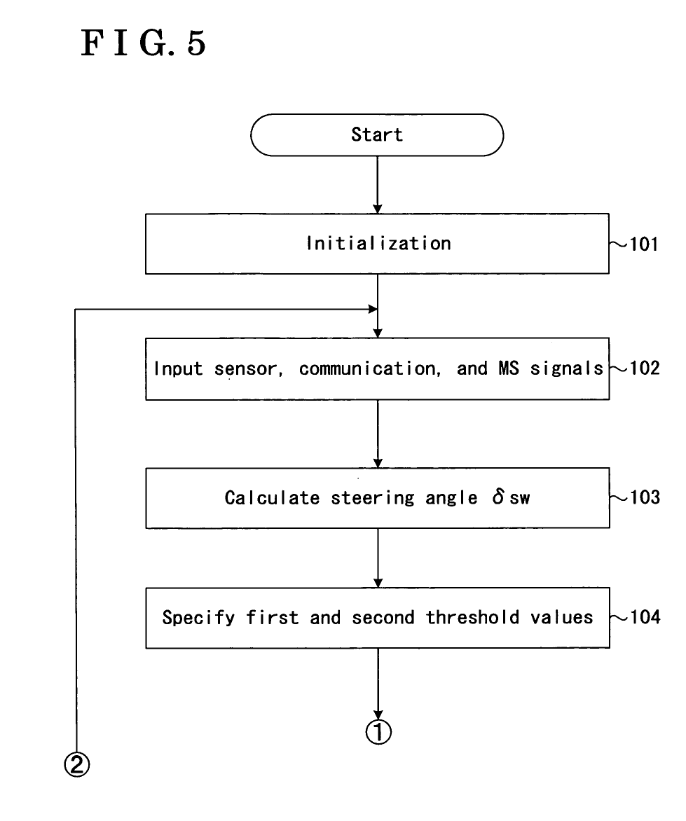

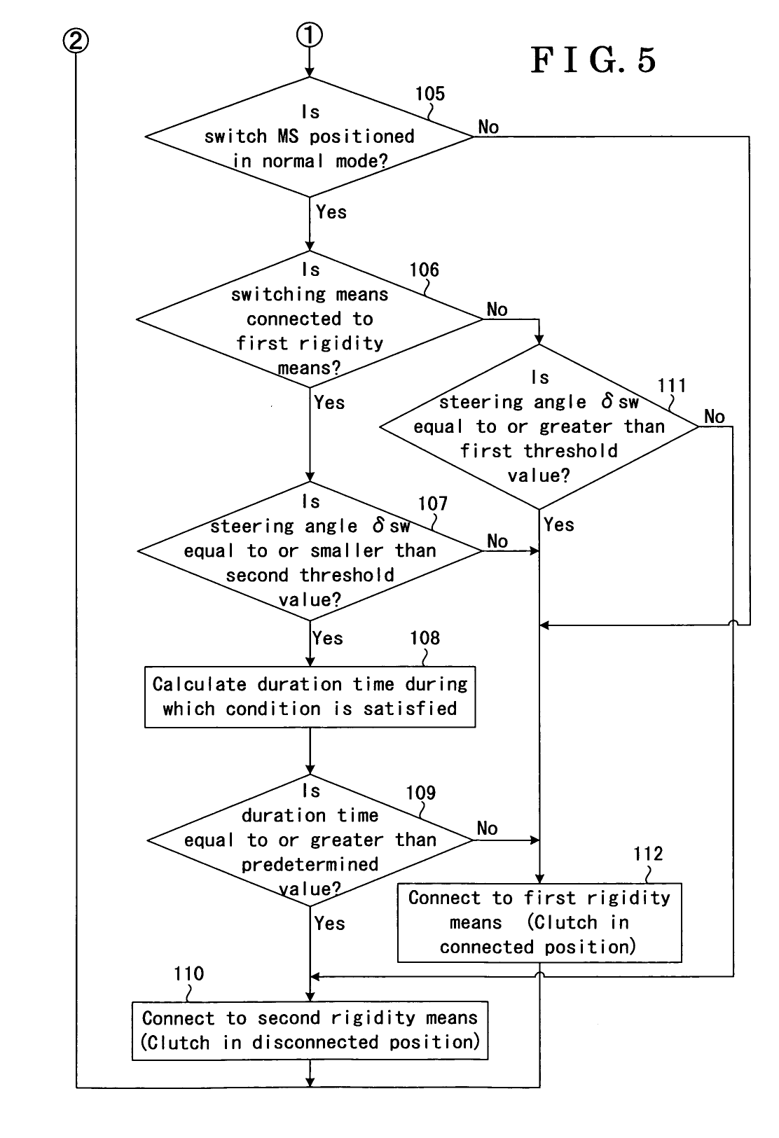

A control for switching the torsional rigidity according to the stabilizer control apparatus having the aforementioned structure is explained below with reference to FIG. 5. As explained by FIG. 9, the rolling motion of a vehicle is caused by the steering wheel operation. Thus, the steering angle δsw of the steering wheel SW is the fastest signal in terms of time for the rolling motion and can be used as a condition for switching the torsional rigidity of the stabilizer STB. The steering angle δsw is generally used as a data with positive and negative signs for the purposes of distinguishing the right turning and the left turning therebetween. However, according to the present embodiment, the torsional rigidity of the stabilizer is switched between the high level (first rigidity means) and the low level (second rigidity means) and a distinction between the right turning and the left turning is not required. Thus, in the following explanation, a value of steering angle is simply described as it indicates an absolute value thereof.

First, in Step 101, an initialization is performed. In Step 102, sensor and communication signals including a steering angle with positive and negative signs and a vehicle speed, and a signal from the mode selection switch MS are input. In Step 103, the steering angle δsw (absolute value) is calculated from the steering angle signal with positive and negative signs. Then, in Step 104, the first threshold value δ1 and the second threshold value δ2 for the steering angle are specified. At this time, the first threshold value δ1 is a reference threshold value for switching to the first rigidity means GS1 while the second threshold value δ2 is a reference threshold value for switching to the second rigidity means GS2. After the first and second threshold values δ1 and δ2 are specified in Step 104, a determination for switching the torsional rigidity by the stabilizer STB is performed.

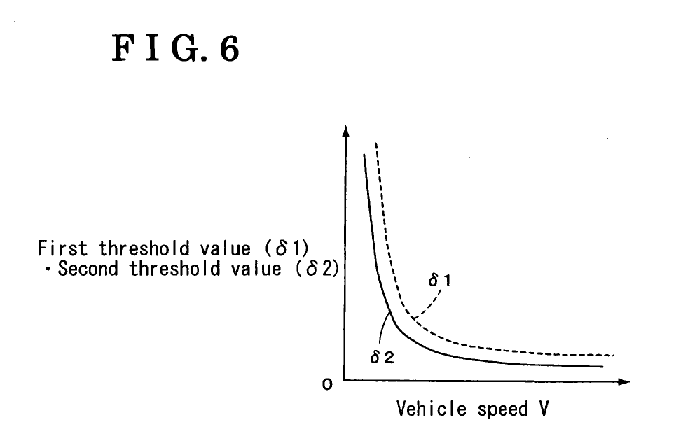

The first threshold value δ1 and the second threshold value δ2 are respectively specified as a function of the vehicle speed V as shown in FIG. 6. The first threshold value 61 is specified in such a manner that the torsional rigidity is switched to the high level in a state in which the torsion is not substantially generated in the stabilizer STB. That is, when the torsional rigidity is switched, the stabilizer characteristics difference between the right turning and the left turning is not recognized as an uncomfortable feeling by a driver.

In Step 105, it is determined whether or not the mode selection switch MS is positioned in the normal mode SM2. When it is determined that the mode selection switch MS is positioned in the sports mode SM1 instead of the normal mode SM2, a process proceeds to Step 112 in which the switching means KR is positioned in the first position so as to be connected to the first rigidity means GS1 (i.e. switching to or maintaining of the first rigidity means GS1). For example, when the mode selection switch MS is switched from the normal mode SM2 to the sports mode SM1 by a driver while the vehicle is in a straight-ahead running, the clutch mechanism CL is required in the connecting position and thus the switching to the first rigidity means GS1 with the high torsional rigidity is performed.

Meanwhile, when it is determined that the mode selection switch MS is positioned in the normal mode SM2 in Step 105, the process proceeds to Step 106 in which it is determined whether or not the switching means KR is in the first position so as to be connected to the first rigidity means GS1. That is, it is determined whether or not the torsional rigidity of the stabilizer STB is high. Then, when it is determined that the switching means KR is in the second position so as to be connected to the second rigidity means GS2 in Step 106, the process proceeds to Step 111 in which the determination for switching to the first rigidity means GS1 is performed on the basis of the first threshold value δ1. In Step 111, when it is determined that the steering angle δsw is smaller than the first threshold value δ1 and thus the condition for switching to the first rigidity means GS1 is not satisfied, the process proceeds to Step 110 so that the switching means KR is maintained in the second position.

In Step 111, when it is determined that the steering angle δsw is equal to or greater than the first threshold value δ1 and thus the condition for switching to the first rigidity means GS1 is satisfied, the switching means KR switches to the first position so as to be connected to the first rigidity means GS1 in Step 112. In Step 106, when it is determined that the switching means KR is in the first position so as to be connected to the first rigidity means GS1, then the steering angle δsw is compared to the second threshold value δ2 in Step 107. When it is determined that the steering angle δsw is greater than the second threshold value δ2 and thus the condition for switching to the second rigidity means GS2 is not satisfied, the process proceeds to Step 112 so that the switching means KR is maintained in the first position.

In Step 107, when it is determined that the steering angle δsw is equal to or smaller than the second threshold value δ2, the process proceeds to Step 108 in which a duration time during which the condition in Step 107 is satisfied is calculated. Then, in Step 109, it is determined whether or not the duration time reaches or exceeds a predetermined value To. When the duration time is smaller than the predetermined value To, the process proceeds to Step 112 in which the switching means KR is maintained in the first position. On the other hand, when the duration time reaches or exceeds the predetermined value To, the switching to the second rigidity means GS2 is conducted in Step 110.

The switching to the second rigidity means GS2 having the low rigidity is not immediately performed when the steering angle δsw satisfies the second threshold value δ2. The switching is performed when the duration time during which the condition for switching to the second rigidity means GS2 is satisfied reaches or exceeds the predetermined value To. Accordingly, since the stabilizer STB is switched to the low torsional rigidity after the rolling motion of the vehicle is sufficiently settled, an unnecessary switching of the torsional rigidity by the stabilizer STB at a time of transient steering can be reduced.

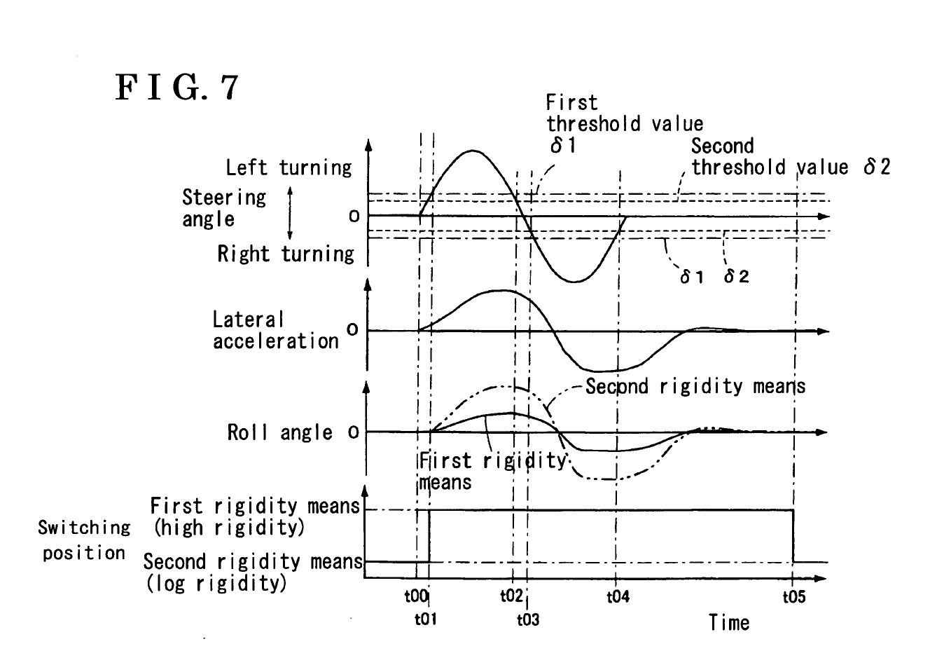

FIG. 7 is a view represented as time series of control operation shown in FIG. 5. In FIG. 7, a vehicle is driving straight-ahead and the switching means KR is in the second position so as to be connected to the second rigidity means GS2. The stabilizer STB is thus in the low torsional rigidity state. In addition, the mode selection switch MS is positioned in the normal mode SM2. At a time of too, the driver starts operating the steering wheel. When the steering angle δsw reaches or exceeds the first threshold value δ1 at a time of t01, the condition for Step 111 in FIG. 5 is satisfied and then the switching means KR switches to the first position so as to be connected to the first rigidity means GS1, thereby achieving the high rigidity state of the stabilizer STB.

The steering angle δsw is the fastest signal input to the rolling motion of the vehicle as mentioned above. Thus, by conducting the switching of the torsional rigidity based on the steering angle, the switching to the first rigidity means GS1 can be performed in a state in which the roll angle is not generated or only a small roll angle is generated. The switching can be conducted in a state in which the torsion is not generated at all or only a small torsion is generated in the stabilizer STB. Then, since the torsional rigidity of the stabilizer STB is switched to the high level, the smaller roll angle is achieved as compared to a case in which the torsional rigidity is in the low level as shown by a chain double-dashed line in FIG. 7 though the roll angel is increased along with the increase of the lateral acceleration.

When the steering wheel SW is returned and thus the steering angle δsw is decreased, the steering angle δsw becomes equal to or smaller than the second threshold value δ2 at a time of t02, which satisfies the condition for Step 107. However, the switching to the second rigidity means GS2 is not immediately performed. A time period (i.e. duration time) during which the steering angle δsw is equal to or smaller than the second threshold value δ2 starts to be counted (i.e. Step 108 in FIG. 5). At a time of t03, the state in which the steering angle δsw is equal to or smaller than the second threshold value δ2 is finished. The time period from t02 to t03 is shorter than the predetermined value To and thus the condition for Step 109 in FIG. 5 is not satisfied. Accordingly, the switching means KR is still positioned in the first position, thereby maintaining the high tortional rigidity of the stabilizer STB.

When a driver returns the steering wheel SW to a straight-ahead driving position and thus the steering angle δsw becomes equal to or smaller than the second threshold value 2, the condition of Step 107 is again satisfied. Then, counting of duration time in Step 108 is started. When the driver keeps the steering wheel SW in the straight-ahead driving position so that the vehicle keeps the straight-ahead running, the condition for Step 109 in FIG. 5 is satisfied at a time of t05. The switching to the second rigidity means GS2 is conducted so that the stabilizer STB is switched in the low torsional rigidity state.

According to the present embodiment, the switching means KR is operated on the basis of the steering angle δsw that is the fastest input to the rolling motion. Thus, the switching of the torsional rigidity can be performed in a state in which the roll angle is not generated or only a small roll angle is generated. As a result, the stabilizer characteristics between the right turning and the left turning are not different from each other and a driver is prevented from having the uncomfortable feeling. Further, when the steering angle δsw becomes equal to or smaller than the predetermined threshold value δ2, the switching to the second rigidity means GS2 is not immediately performed. The switching to the second rigidity means GS2 is performed on the basis of the duration time during which the second threshold value δ is satisfied. Thus, at a time of transient steering such as a slalom running, the unnecessary switching of the torsional rigidity does not occur, which prevents the driver from having the uncomfortable feeling such as a sudden change of the roll angle.

The determination for switching the torsional rigidity in FIG. 5 is performed on the basis of the steering angle δsw. Alternatively, the switching can be performed on the basis of an estimated lateral acceleration obtained from the steering angle δsw. In this case, an estimated lateral acceleration Gye is calculated from the steering angle δsw obtained from the sensor and the communication bus read out in Step 102 and the vehicle speed V, on the basis of a following formula:
Gye=(V²·|δsw|)/{L·N·(1+Kh·V²)}
Where N represents a steering gear ratio, L represents a wheel base of a vehicle, and Kh represents a stability factor.

The first threshold value Gy1 used for switching to the first rigidity means GS1 and the second threshold value Gy2 used for switching to the second rigidity means GS2 are respectively represented as the dimension of lateral acceleration. The first threshold value Gy1 and the second threshold value Gy2 are specified in such a way that the torsioanl rigidity is not switched by an adjustment steering angle for maintaining a straight running on a rough road and is surely switched before the torsion is generated in the stabilizer STB when the turning movement of the vehicle is started. For example, the first and second threshold values Gy1 and Gy2 can be specified between 0.05G and 0.1G in the dimension of lateral acceleration. The first and second threshold values Gy1 and Gy2 can be specified as fixed values or can be specified on the basis of the vehicle speed V.

According to the system structure in FIG. 4, the stabilizers STBf and STBr are arranged at front and rear portions of the vehicle, respectively. However, a structure, by which the stabilizer STBf is provided at the front side while a normal stabilizer not equipped with the switching means KR is provided at the rear side, is acceptable. Alternatively, a structure, by which the stabilizer STBf is provided at the front side while no stabilizer is provided at the rear side, is also acceptable. According to such structure, a stabilizer system can be simplified as a whole, which leads to a reduction of cost. In addition, a ride comfort in a straight-ahead running may be further increased due to the following reasons.

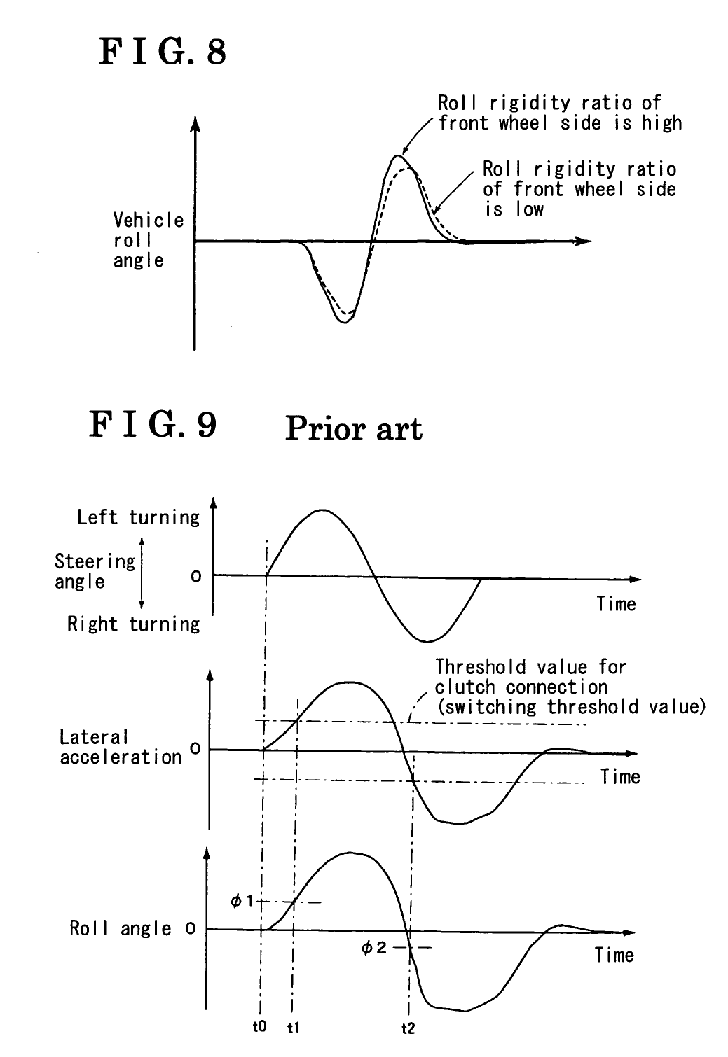

A roll rigidity of a vehicle, which is decided on the basis of a spring rigidity of a suspension spring (not shown) and the torsional rigidity of the stabilizers STBf and STBr, is generally specified in such a manner that a ratio of roll rigidity of the front wheel side is set to approximately 55% to 60% in view of driving stability. On the other hand, in the cases where either the right wheel or the left wheel overcomes a projection on the road, only a small fluctuation in roll angle, which leads to an excellent ride comfort, can be obtained when the roll rigidity ratio of the front wheel side is lower as shown in FIG. 8.

According to the present embodiment, the torsional rigidity of the stabilizer STB can be switched substantially immediately before the rolling motion is started. Thus, with the stabilizer STBf arranged at the front wheel side, the ride comfort is increased by the low torsional rigidity of the stabilizer STBf at the front wheel side at a time of straight-ahead running of the vehicle. Then, when the turning operation is started by the operation of the steering wheel SW, the tortional rigidity of the stabilizer STBf is switched to the high level substantially immediately before the rolling motion is started, thereby achieving the driving stability. In such structure, the roll rigidity ratio of the front wheel is set to approximately 40% to 45% when the torsional rigidity of the stabilizer STBf is in the low level (second rigidity means GS2). When the torsional rigidity is switched to the high level (first rigidity means GS1), the roll rigidity ratio of the front wheel is set to approximately 55% to 60%.

As mentioned above, according to the aforementioned stabilizer control apparatus that can switch the torsional rigidity of the stabilizer STB between the high level and the low level, the switching is performed on the basis of the steering angle δsw or the estimated lateral acceleration Gye obtained from the steering angle δsw. Thus, the switching means KR performs the switching in a state in which the torsion is not generated or only the small torsion is generated in the stabilizer STB. As a result, the occurrence of difference in stabilizer characteristics between the right turning and the left turning is avoided and the driver is prevented from having the uncomfortable feeling.

Specifically, the switching from the high torsional rigidity to the low torsional rigidity is conducted when the duration time during which the condition for switching is satisfied (i.e. steering angle δsw is equal to or smaller than the second threshold value δ2, or the estimated lateral acceleration Gy1 is equal to or smaller than the second threshold value Gy2) reaches or exceeds the predetermined value. At a time of the transient steering such as the slalom running, the sudden change of roll angle, and the like can be avoided, thereby preventing the driver to have the uncomfortable feeling.

Further, the arrangement of the stabilizer STB that can switch the torsional rigidity only at the front wheel side achieves the simplification of the system structure as well as appropriate setting of the roll rigidity at a time of both straight-ahead running and turning. Accordingly, improvement of ride comfort and assurance of driving stability can be both achieved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A stabilizer control apparatus for controlling a torsional rigidity of a stabilizer arranged between a right wheel and a left wheel of a vehicle, comprising:
a turning state detecting means for detecting a turning state quantity of the vehicle;
a switching means for switching the torsional rigidity of the stabilizer and including a first position in which a first torsional rigidity is achieved and a second position in which a lower torsional rigidity than the first torsional rigidity is achieved, the switching means switching between the first position and the second position based on the turning state quantity detected by the turning state detecting means; and
the switching means switching the first position to the second position when a state in which the turning state quantity detected by the turning state detecting means is equal to or smaller than a predetermined value continues for a predetermined time or more.

2. A stabilizer control apparatus according to claim 1, further comprising:
a vehicle speed detecting means for detecting a speed of the vehicle;
a first threshold value setting means for setting a first threshold value for the turning state quantity based on the vehicle speed detected by the vehicle speed detecting means;
a second threshold value setting means for setting a second threshold value for the turning state quantity based on the vehicle speed detected by the vehicle speed detecting means; and
the switching means switching the second position to the first position when the turning state quantity detected by the turning state detecting means is equal to or greater than the first threshold value, and switching the first position to the second position when the state in which the turning state quantity detected by the turning state detecting means is equal to or smaller than the second threshold value continues for the predetermined time or more.

3. A stabilizer control apparatus according to claim 2, further comprising:
the turning state detecting means including a steering angle detecting means for detecting a steering angle of the vehicle;
the first threshold value setting means and the second threshold value setting means setting, on the basis of the vehicle speed, the first threshold value and the second threshold value respectively for the steering angle; and
the switching means switching the second position to the first position when the steering angle is equal to or greater than the first threshold value and switching the first position to the second position when the state in which the steering angle is equal to or smaller than the second threshold value continues for the predetermined time or more.

4. A stabilizer control apparatus according to claim 2, further comprising:
the turning state detecting means including a steering angle detecting means for detecting a steering angle of the vehicle, and a lateral acceleration detecting means for calculating an estimated lateral acceleration based on the steering angle detected by the steering angle detecting means and the vehicle speed detected by the vehicle speed detecting means;
the first threshold value setting means and the second threshold value setting means setting, on the basis of the vehicle speed, the first threshold value and the second threshold value respectively for the estimated lateral acceleration, and
the switching means switching the second position to the first position when the estimated lateral acceleration is equal to or greater than the first threshold value and switching the first position to the second position when the state in which the estimated lateral acceleration is equal to or smaller than the second threshold value continues for the predetermined time or more.

5. A stabilizer control apparatus according to claim 2, wherein the second threshold value setting means specifies the second threshold value in such a manner that the second threshold value is smaller than the first threshold value.
